(19) United States
(12) Patent Application Publication
(10) Pub. No.: US 2025/0333985 A1
(43) Pub. Date: Oct. 30, 2025

(54) MOTOR VEHICLE LOCKING DEVICE

(71) Applicant: Kiekert Aktiengesellschaft, Heiligenhaus (DE)

(72) Inventors: Aleš KEJDANA, Prelouc (CZ); Jan SUK, Pardubice (CZ)

(73) Assignee: Kiekert Aktiengesellschaft, Heiligenhaus (DE)

(21) Appl. No.: 18/869,363

(22) PCT Filed: May 23, 2023
(86) PCT No.: PCT/DE2023/100373

§ 371 Date: Dec. 3, 2024

(30) Foreign Application Priority Data
Jun. 3, 2022 (DE) 10 2022 114 137.3

(51) Int. Cl. E05B 77/36; E05B 83/24

(52) U.S. Cl. CPC E05B 77/36; E05B 83/243

(57) ABSTRACT

The invention relates to a motor vehicle locking device, in particular a motor vehicle lock and preferably a motor vehicle hood lock (1), which is equipped with a locking mechanism (4, 5) which consists substantially of a rotary latch (4) and a pawl (5). Also provided is an ejector lever (7) which is preloaded by means of a spring (6) and is intended to act upon a locking bolt (3) which interacts with the locking mechanism (4, 5). According to the invention, the spring (6) is formed as a leg spring (6) which is fastened to a bearing dome (8) defining an axis of the ejector lever (7).

The invention relates to a motor vehicle locking device, in particular a motor vehicle lock, preferably a motor vehicle hood lock, having a locking mechanism which consists substantially of a rotary latch and a pawl, and having an ejector lever which is preloaded by a spring to act upon a locking bolt which interacts with the locking mechanism.

Motor vehicle locking devices generally face the problem that rattling noises can occur during operation of the motor vehicle. These can often be attributed to the fact that a hood, a cover, a door, a flap, etc., secured against a motor vehicle body by means of the motor vehicle locking device performs relative movements during operation in relation to the motor vehicle body in question. For this reason, motor vehicle locks, and preferably motor vehicle hood locks, are designed in such a way that the ejector lever acts upon the locking bolt. This is ensured by the spring, which preloads the ejector lever accordingly.

This is usually done in such a way that the ejector lever, which is preloaded by the spring, rests against the underside of the locking bolt and moves it into a clamping position. As a rule, the locking bolt is located in the inlet mouth of the rotary latch. Because the locking bolt has a certain amount of play in relation to the inlet mouth, the ejector lever, which is preloaded by the spring, ensures that the locking bolt is held in the clamping position within the inlet mouth when the locking mechanism is in the closed position. For this purpose, the locking bolt typically rests on one of the catch legs of the rotary latch.

In fact, the design is usually such that the rotary latch has the relevant catch leg and a stop leg, which define the inlet mouth between them. Using the ejector lever, the locking bolt can now be placed on one of the two legs inside the inlet mouth, taking into account the spring force on the ejector lever. This is usually the catch leg. In any case, this ensures, in particular in the closed position of the locking mechanism, that relative movements observed during operation of the motor vehicle locking device between the locking bolt and the rotary latch or the locking mechanism or even inside the inlet mouth are no longer observed.

The generic prior art according to DE 10 2006 002 338 A1 proceeds at this point in such a way that a lifting part is implemented as an ejector lever. The lifting part is acted upon by means of a force accumulator, and a front flap on the locking bolt is thus moved into a raised position. The force accumulator can be superposed leaf springs. These act upon the lifting part or ejector lever from the outside. This is relatively complex in terms of installation technology because, on the one hand, the leaf springs have to be installed inside a housing which accommodates the motor vehicle locking device and, on the other hand, the lifting part or the ejector lever has to be installed next to other elements of the motor vehicle locking device. In addition, the use of the additional leaf springs in conjunction with the lifting part or ejector lever leads to a relatively bulky structure.

In the known teaching, the ejector lever is acted upon with the help of the force accumulator or the leaf springs in such a way that the overall vibration behavior is improved. In fact, such vibrations occur, for example, in the front hood of a motor vehicle when the vehicle drives over undulating road surfaces or when different aerodynamic forces act upon the front hood due to different speeds. Wind forces or crosswinds can also cause the front hood to move, even when the front hood is in its closed position relative to the vehicle body, and the same applies to the vehicle locking device.

The invention is based upon the technical problem of further developing such a motor vehicle locking device in such a way that rattling noises are still avoided while maintaining a functional design, wherein a particularly compact and easy-to-install variant is sought.

To solve this technical problem, a generic motor vehicle locking device in the context of the invention is characterized in that the spring preloading the ejector lever is designed as a leg spring which is fixed to a bearing dome defining an axis of the ejector lever.

According to the invention, a special spring is first used, viz., a leg spring having a winding portion and two legs extending therefrom. The leg spring in question is fixed to a bearing dome. The bearing dome is used to define an axis or an axis of rotation of the ejector lever. In this way, it is already possible that the leg spring in question, the bearing dome, and the ejector lever as a whole define and also can define a structural unit.

In fact, at this point and advantageously, the leg spring in question, together with the bearing dome and the ejector lever, define a structural unit which can be fixed in a locking manner to a housing of the motor vehicle locking device. This makes installation particularly easy and simultaneously ensures a compact structure. In contrast, such installation in one go is not possible at all with the generic prior art according to DE 10 2006 002 338 A1.

In the known teaching, the ejector lever, the associated spring, and also the bearing dome are obviously fixed separately from one another in or on the housing of the motor vehicle locking device and mounted thereon, which is particularly time-consuming and at the same time also requires a mutual alignment of the aforementioned individual elements with respect to one another.

At the same time, the invention provides a solution which is still functional, because the leg spring also prevents any rattling noises—for example, from a hood or flap. Specifically, this is usually done in such a way that the leg spring encloses with its winding portion the bearing dome in question. In most cases, the leg spring is designed in such a way that its loose leg acts upon the ejector lever, while its fixed leg is fixed to the housing of the motor vehicle locking device.

The loose leg of the leg spring can therefore move together with the ejector lever and ensures that the ejector lever rests against the locking bolt so as to be spring-loaded. Most of the time, the ejector lever rests on a lower edge or an underside arc of the locking bolt. The locking bolt is in turn attached to a hood or flap. In this way, the leg spring ensures that, when the locking mechanism is in the closed position, the locking bolt inside the inlet mouth is pressed against one of the two legs of the rotary latch by means of the spring-loaded ejector lever. Most of the time, this leg is the catch leg of the rotary latch. This effectively suppresses any rattling noises from the hood or flap in question during operation.

A particularly simple and functional installation is provided in the event that the winding portion enclosing the bearing dome is or will be mounted on the bearing dome in question. In addition, to actuate the ejector lever, the procedure is usually such that the loose leg, which moves together with the ejector lever, of the leg spring engages under a contact edge of the ejector lever for the locking bolt resting thereon.

This means that the locking bolt usually rests with its lower edge or its arc on the corresponding contact edge of the ejector lever. The contact edge of the ejector lever is in turn gripped underneath by the loose leg as a component of the leg spring. This allows the loose leg of the leg spring to act directly upon the contact edge of the ejector lever and thus upon the locking bolt.

In contrast, the fixed leg generally engages in an opening in the housing in a locking manner. This means that the fixed leg ultimately also provides the locking connection of the structural unit consisting of the leg spring together with the bearing dome and the ejector lever on the housing.

In addition, it has proven to be advantageous if the legs adjoining the winding portion, i.e., the loose leg and the fixed leg, form an obtuse angle between them. This obtuse angle takes into account the installation conditions and the topology of the ejector lever. This is because the ejector lever is usually mounted coaxially with the locking pawl. Accordingly, the common axis of the ejector lever and the pawl is located at a distance from an axis of the rotary latch and thus also from the inlet mouth of the rotary latch in which the locking bolt is caught.

As a result, the ejector lever is usually designed as a two-arm lever, which has the contact edge for the locking bolt on one lever arm and a connection on the other opposite lever arm for, for example, additional manual or motorized actuation. This two-armed, more or less elongated or obtuse-angled design of the ejector lever is then also reflected in the fact that the leg spring is also designed with an obtuse angle, following the design of the ejector lever.

Finally, in this connection, it has proven to be particularly advantageous if the vertex of the obtuse angle formed by the two legs is arranged in the region of a highest point of the winding portion in the installation position. This means that as soon as the motor vehicle locking device is mounted in or on an associated motor vehicle, the vertex in question is located at the highest point of the winding portion. This highest point usually occurs in a so-called vertical axis direction or Z-direction. This allows the fixed leg to easily engage in a locking manner in the opening of the housing. The opening in question is usually located on a short L-leg of the usually L-shaped housing or a lock case which is usually realized at this point.

The short L-leg in question extends in the installation position of the motor vehicle locking device and thus also of the housing mostly in the vehicle transverse or Y-direction. In contrast, the long L-leg, on which the locking mechanism and the ejector lever are typically mounted, is usually oriented in the Z-direction in cross-section, or its longitudinal extension is provided in the transverse direction or Y-direction.

In this way, the vertex or highest point of the winding portion is arranged in the immediate vicinity of the short L-leg of the housing. This provides additional security inside the housing for the leg spring attached to the bearing dome, as the coil winding portion cannot be removed or detached from the bearing dome.

The result is a motor vehicle locking device which is particularly compact, easy to install, and at the same time prevents any rattling noises from a front hood, tailgate, or any other flap or door on a motor vehicle equipped therewith. This can ultimately be attributed to the special leg spring which acts upon the ejector lever, and its design. In fact, the leg spring is taken up as a component of a locking connection of the structural unit consisting of a leg spring, bearing dome, and ejector lever, which locking connection is realized at this point and is in principle also detachable. The locking connection between, on the one hand, the fixed leg of the leg spring and, on the other, the opening in the housing of the motor vehicle locking device is observed. These are the main advantages.

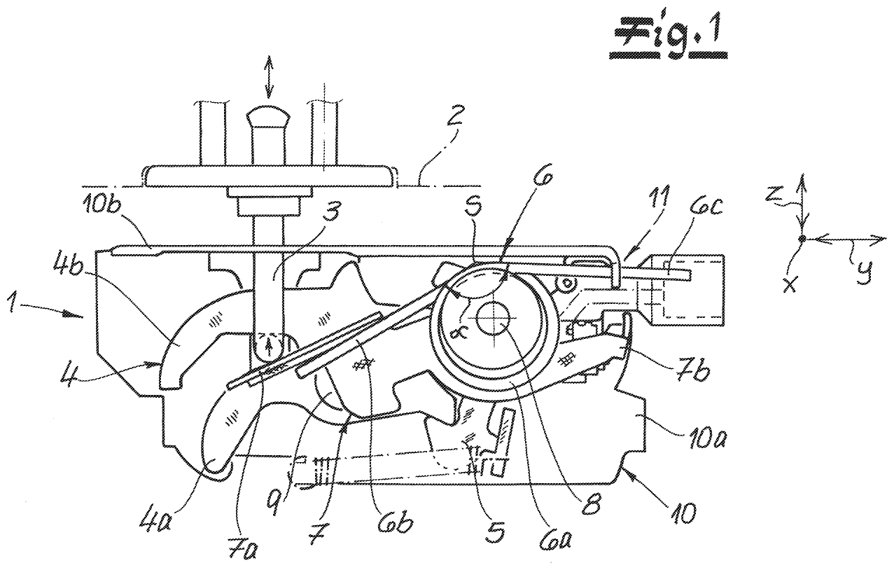

The invention is explained in greater detail below with reference to a drawing which shows only one exemplary embodiment. The sole FIG. 1 shows the motor vehicle locking device according to the invention in an overview.

FIG. 1 shows a motor vehicle locking device which is generally designed as a motor vehicle lock, and very specifically as a motor vehicle hood lock 1. The motor vehicle hood lock 1 shown in FIG. 1 can be used to secure and lock a front hood 2, which is merely indicated here. For this purpose, a locking bolt 3 adjoins the front hood 2 or is connected to the front hood 2, which locking bolt in turn interacts with a locking mechanism 4, 5 as an essential component of the motor vehicle locking device or the motor vehicle hood lock 1.

Specifically, the locking mechanism 4, 5 substantially consists of a rotary latch 4 and a pawl 5. The rotary latch 4 has a stop leg 4a and a catch leg 4b, which define between them an inlet mouth into which the locking bolt 3 is completely retracted and held in the closed position or main locking position of the locking mechanism 4, 5 shown in FIG. 1.

An ejector lever 7 preloaded by a spring 6 is then provided to act upon the locking bolt 3. By means of the spring 6, the ejector lever 7 is preloaded such that the locking bolt 3 inside the inlet mouth according to the exemplary embodiment is held in contact with the catch leg 4b, so that any rattling noises or relative movements of the locking bolt 3 inside the inlet mouth of the rotary latch 4 between the stop leg 4a and catch leg 4b are suppressed. This is schematically indicated by an arrow in FIG. 1.

It can be seen that the locking bolt 3 in the exemplary embodiment is bow-shaped or U-shaped and rests with its lower edge or underside on the ejector lever 7 in question and specifically on a contact edge 7a of the ejector lever 7. The ejector lever 7 is in turn mounted on a bearing dome 8 as an axis of rotation. Another bearing dome 9 can be used to mount the rotary latch 4 so that it can rotate. Both bearing domes 8, 9 define axes of rotation running largely parallel to one another and are rotatably mounted in a housing or lock case 10 of the motor vehicle locking device.

In the exemplary embodiment and in cross-section, the lock case 10 is L-shaped with a long L-leg 10a and a short L-leg 10b. The locking mechanism 4, 5 and the ejector lever 7 are mounted on the long L-leg 10a of the lock case 10. In contrast, the short L-leg 10b typically and predominantly serves to stiffen the lock case 10. In addition, the overall design is such that, in the installation position of the motor vehicle locking device or the motor vehicle hood lock 1 shown in FIG. 1, the long L-leg 10a is largely aligned in a vertical axis or Z-direction of the motor vehicle in cross-section and extends longitudinally in a vehicle transverse direction or Y-direction. The short L-leg 10b of the lock case is designed in its longitudinal extension in the respective Y-direction or transverse direction, and extends in its width in the longitudinal direction or X-direction, which is not explicitly shown in FIG. 1, but is merely indicated by a dot.

Of course, these location and orientation details are merely examples, because the motor vehicle locking device in question can generally also be oriented and arranged with the longitudinal extension of the lock case 10 in the longitudinal direction or X-direction of the motor vehicle. In this case, for example, two motor vehicle locking devices are realized on both sides of a hood or front hood 2. However, this is not shown in detail.

Either way, and according to the invention, the spring 6 already mentioned, which acts upon the ejector lever 7, is designed as a leg spring 6 according to the exemplary embodiment. The leg spring 6 is also fixed to the bearing dome 8 defining the axis of the ejector lever 7. The design is such that the leg spring 6 in question encloses with its winding portion 6a the bearing dome 8. In the context of the exemplary embodiment, it can be seen that the winding portion 6a encloses the bearing dome 8 in question at a distance, so that movements between the two legs 6b and 6c extending from the winding portion 6a can be easily transmitted to the winding portion 6a, reducing or expanding its diameter.

In fact, the design is such that the leg spring 6 acts with its loose leg 6b upon the ejector lever 7. This means that the loose leg 6b moves together with the ejector lever 7. In contrast, the further second leg is fixed as a fixed leg 6c to the housing and specifically to the lock case 10.

For this purpose, the loose leg 6b engages under the previously mentioned contact edge 7a of the ejector lever 7 for the locking bolt 3 resting thereon. In contrast, the fixed leg 6c of the leg spring 6 engages in a locking manner in an opening 11 in the housing 10 or the lock case 10. Specifically, the opening 11 is provided and realized in the short L-leg 10b of the L-shaped lock case 10.

It can be seen that the two legs 6b, 6c of the leg spring 6 which adjoin the winding portion 6a form an obtuse angle a between them. Both legs 6b, 6c start from a vertex S of the corresponding angle α. The obtuse angle a between the two legs 6b, 6c is designed to be comparable to an obtuse angle between two lever arms of the ejector lever 7. In fact, the ejector lever 7 is equipped with a lever arm, supporting the contact edge 7a, and a further lever arm 7b, which form an obtuse angle between them in a similar manner to the two legs 6b, 6c of the leg spring 6. A handle or a drive may or may not be connected to the further arm 7b of the ejector lever 7.

The leg spring 6 is mounted with its winding portion 6a on the bearing dome 8. For this purpose, the bearing dome 8 can be equipped with an end stop flange which prevents the winding portion 6a from slipping off the bearing dome 8. Furthermore, it can be seen that the ejector lever 7 is mounted coaxially with the pawl 5 by means of the bearing dome 8. This means that the pawl 5 also uses the bearing dome 8 to define its axis of rotation.

In this way, the leg spring 6, the bearing dome 8, and the ejector lever 7 can together define a structural unit 6, 7, 8. The structural unit 6, 7, 8 can be fixed together and as a whole, as well as in a locking manner, to the housing 10, and specifically to the lock case 10 according to the exemplary embodiment. In this case, a locking connection 6c, 11 is realized, which specifically comprises the fixed leg 6c of the leg spring 6 on the one hand and the opening 11 in the lock case 10 on the other. At the same time, the pawl 5, which is mounted on the bearing dome 8 coaxially with the structural unit 6, 7, 8, is fixed in the lock case 10.

In principle, the locking connection can of course also be designed differently. In any case, the structural unit 6, 7, 8 in question can be combined with the housing or the lock case 10 in a locking manner, which allows a particularly simple and quick installation. Furthermore, it can be seen that, in the installation position according to the illustration in FIG. 1, the vertex S of the obtuse angle α is arranged in the region of a highest point of the winding portion 6a.

This means that the winding portion 6a on the bearing dome 8 in the front view is equipped with a highest point in the Z-direction or vertical axis direction of the motor vehicle in its installation position. This highest point coincides approximately with the vertex S of the obtuse angle a of the two legs 6b, 6c of the leg spring 6. As a result, the vertex S in question is located in the immediate vicinity of the short L-leg 10b of the lock case 10, thereby providing additional security to the short L-leg 10b and thus also the leg spring 6, so that it cannot become detached from the bearing dome 8 which supports it. These are the main advantages.

### LIST OF REFERENCE SIGNS

Motor vehicle hood lock 1
Front hood 2
Locking bolt 3
Rotary latch 4
Stop leg 4a
Catch leg 4b
Locking mechanism 4, 5
Leg spring 6
Winding portion 6a
Loose leg 6b
Leg 6b, 6c
Ejector lever 7
Contact edge 7a
Lever arm 7b
Bearing dome 8
Structural unit 6, 7, 8
Bearing dome 9
Lock case 10
L-leg 10a
T-leg 10b
Opening 11
Vertex S
Angle α

1. A motor vehicle locking device comprising:
a locking mechanism which includes a rotary latch and a pawl,
a spring, and
an ejector lever that is fixed to a bearing dome, the ejector lever being preloaded by the spring to act upon a locking bolt which interacts with the locking mechanism, wherein the spring is formed as a leg spring which is fastened to the bearing dome defining an axis of the ejector lever.

2. The motor vehicle locking device according to claim 1, wherein the leg spring has a winding portion and encloses the bearing dome with the winding portion.

3. The motor vehicle locking device according to claim 1, further comprising a housing, wherein the leg spring has a loose leg and a fixed leg, and the leg spring acts with the loose leg upon the ejector lever while its fixed leg is fixed to the housing.

4. The motor vehicle locking device according to claim 2, wherein the winding portion is mounted on the bearing dome.

5. The motor vehicle locking device according to claim 3, wherein the loose leg engages under a contact edge of the ejector lever for the locking bolt resting on the contact edge.

6. The motor vehicle locking device according to claim 3, wherein the fixed leg engages in an opening in the housing in a locking manner.

7. The motor vehicle locking device according to claim 3, wherein the leg spring includes a winding portion from which the loose leg and the fixed leg extend, the loose leg and the fixed leg adjoining the winding portion at an obtuse angle between the loose and fixed legs.

8. The motor vehicle locking device according to claim 7, wherein a vertex of the obtuse angle is arranged in a region of a highest point of the winding portion in an installation position.

9. The motor vehicle locking device according to claim 1, wherein the ejector lever is mounted coaxially with the pawl about a common axis.

10. The motor vehicle locking device according to claim 1, further comprising a housing, wherein the leg spring together with the bearing dome and the ejector lever define a structural unit that is fixed in a locking manner on the housing.

11. The motor vehicle locking device according to claim 1, wherein the rotary latch includes a first a leg and a second leg that define an inlet mouth, and when the locking mechanism is in a closed position, the locking bolt is positioned in the inlet mouth with the ejector lever preloaded by the spring pressing the locking bolt against at least one of the first and second legs of the rotary latch.

12. The motor vehicle locking device according to claim 5, wherein the loose leg of the leg spring directly grips the ejector lever from underneath the contact edge.

13. The motor vehicle locking device according to claim 9, wherein the common axis of the ejector lever and the pawl is spaced at a distance from an axis of the rotary latch.

14. The motor vehicle locking device according to claim 5, wherein the ejector lever has a first arm that includes the contact edge for the locking bolt, and a second arm that is angled at an obtuse angle relative to the first arm.

15. The motor vehicle locking device according to claim 3, wherein the housing is L-shaped, and the fixed leg of the leg spring engages with a short leg of the L-shaped housing.

16. The motor vehicle locking device according to claim 15, wherein a long leg of the L-shaped housing is aligned perpendicularly relative to the short leg of the L-shaped housing, and the locking lever and the ejector lever are mounded on the long leg.
